(19) United States
(12) Patent Application Publication
(10) Pub. No.: US 2006/0176875 A1
(43) Pub. Date: Aug. 10, 2006

(54) IP telephone exchange and IP telephone terminal

(75) Inventor: Emi Senga, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/331,273

(22) Filed: Jan. 13, 2006

(30) Foreign Application Priority Data
Jan. 13, 2005 (JP) P2005-006877

(51) Int. Cl. H04L 12/56; H04L 12/66; H04L 12/28; H04J 3/22; H04J 3/16

(52) U.S. Cl. 370/352; 370/466; 370/401

(57) ABSTRACT

An IP telephone exchange connects an IP telephone terminal and a non-IP telephone terminal to enable conversation between therebetween. The IP telephone exchange includes a communication control section, a voice channel, a control channel and a voice channel management section. The communication control section conducts data communications with the IP and non-IP telephone terminals. The voice channel interconverts between non-IP voice data and IP voice data. The control channel communicates a call control signal with the IP and non-IP telephone terminals. The voice channel management section detects presence or absence of an available voice channel when communication connection is established between the IP and non-IP telephone terminals based on the call control signal. The voice channel management section notifies a calling telephone terminal and a called telephone terminal that no available voice channel exists, if the voice channel management section detects no available voice channel.

This application is based upon and claims the benefit of priority from the prior Japanese Patent Application No. 2005-6877 filed on Jan. 13, 2005, the entire contents of which are incorporated herein by reference.

### BACKGROUND OF THE INVENTION

1. Field of the Invention

This invention relates to an IP telephone exchange and an IP telephone terminal for transferring voice data on an IP network using IP telephones (Internet Protocol Telephones).

2. Description of the Related Art

In recent years, IP has also sprung into wide use in the telephone exchange system field because of the remarkable progress of VoIP (Voice over Internet Protocol) technology, and an IP telephone exchange that accommodates IP telephone terminals has been becoming the standard in the field. For example, in the case where an enterprise, etc. introduces an IP telephone exchange, an extension network may be constructed only using an IP network for IP telephone terminals, but often a system results wherein an already existing non-IP extension network and a non-IP public switched telephone network are mixed with the IP network. At this time, to enable conversation between an IP telephone terminal and a non-IP telephone terminal (or public switched telephone network), interconversion between IP voice data (UDP packet) and non-IP voice data (for example, PCM signal) is necessary for the IP telephone exchange, and a voice channel for executing the interconversion, for example, a DSP (Digital Signal Processor) is indispensable. However, generally, sufficient voice channels (DSPs) for the number of IP telephone terminals connected to the IP telephone exchange may be unable to be installed because of the cost restriction, etc. If telephone conversations concentrate and no available voice channels exist, voice data cannot be transferred and conversation between IP telephone terminals is hindered.

Generally, if telephone conversation cannot be established for some reason, for example, when the called party is already having a telephone conversation, etc., the following method, etc., is available: A busy tone is returned to the calling party or a specific sound is produced to inform the called party that a new call comes, and the called party switches to the new incoming call, thereby switching the telephone conversation for making possible new telephone conversation. (See JP 2004-187082 A)

However, the method disclosed in JP 2004-187082 A is applied to the operation when the called party is having a telephone conversation and the called party can switch telephone conversation, thereby selectively establishing telephone conversation. However, if available voice channels run short in a network in which non-IP telephones and IP telephones are mixed, voice data cannot be transferred. Even if communication connection were established, it would be substantially impossible that both parties have a conversation therebetween.

### SUMMARY OF THE INVENTION

The invention provides an IP telephone exchange and an IP telephone terminal, which can be used conveniently even if available voice channels for conversation between non-IP and IP telephones run short in an IP telephone exchange system wherein non-IP and IP telephones are mixed.

According to one embodiment of the invention, an IP telephone exchange connects at least one IP telephone terminal connected to an IP network and at least one non-IP telephone terminal connected to a non-IP network to enable conversation between the IP telephone terminal and the non-IP telephone terminal. The IP telephone exchange includes a communication control section, a voice channel, a control channel and a voice channel management section. The communication control section conducts data communications with the IP telephone terminal and the non-IP telephone terminal. The voice channel interconverts between non-IP voice data and IP voice data. The control channel communicates a call control signal with the IP telephone terminal and the non-IP telephone terminal. The voice channel management section detects presence or absence of an available voice channel when communication connection is established between the IP telephone terminal and the non-IP telephone terminal on a basis of the call control signal. The voice channel management section notifies a calling telephone terminal and a called telephone terminal that no available voice channel exists, if the voice channel management section detects no available voice channel.

According to this configuration, there can be provided the IP telephone exchange and an IP telephone terminal, which can be used conveniently even if available voice channels for conversation between non-IP and IP telephones run short in an IP telephone exchange system wherein non-IP and IP telephones are mixed.

### BRIEF DESCRIPTION OF THE DRAWINGS

In the accompanying drawings:

FIG. 1 is a drawing to show the general configuration of an IP telephone exchange system according to a first embodiment of the invention;

FIG. 2 is a drawing to show the general configuration of the IP telephone exchange system according to the first embodiment of the invention;

FIG. 3 is a plan view to show the appearance of an IP telephone terminal according to the first embodiment of the invention;

FIG. 4 is a flowchart to show the operation of an IP telephone exchange of the first embodiment of the invention;

FIG. 5 is a flowchart to show the operation of the IP telephone exchange of the first embodiment of the invention;

FIG. 6 is a flowchart to show the operation of an IP telephone exchange of a second embodiment of the invention; and

FIG. 7 is a flowchart to show the operation of the IP telephone exchange of the second embodiment of the invention.

### DETAILED DESCRIPTION OF EMBODIMENTS OF THE INVENTION

IP telephone exchanges and IP telephone terminals according to embodiments of the invention will be described with reference to the accompanying drawings.

### First Embodiment

A first embodiment of the invention will be described with reference to the accompanying drawings.

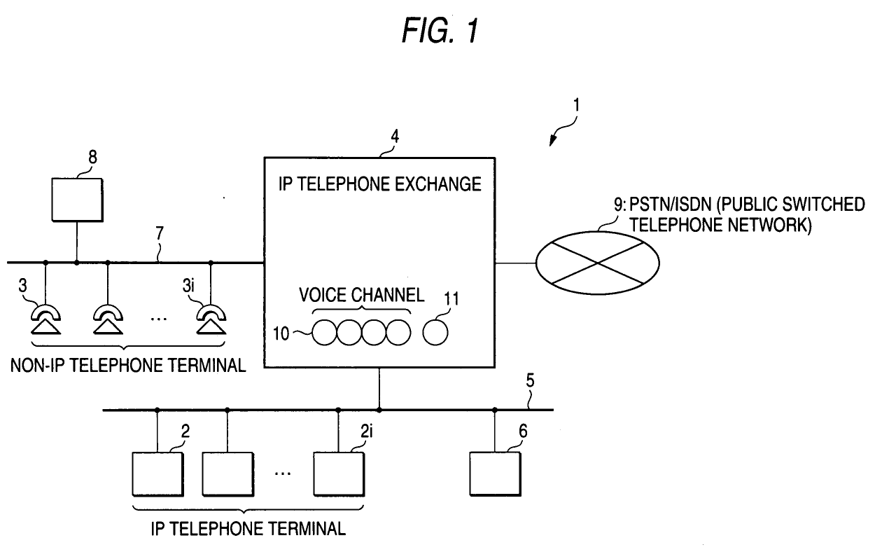

FIG. 1 is a drawing to show the configuration of an IP telephone exchange system including an IP telephone exchange and IP telephone terminals according to the first embodiment of the invention.

In FIG. 1, an IP telephone exchange system 1 is mainly includes IP telephone terminals 2 to 2i, non-IP telephone terminals 3 to 3i, and an IP telephone exchange 4 for connecting the IP telephone terminals 2 and the non-IP telephone terminals 3. The IP telephone terminals 2 to 2i are connected to the IP telephone exchange 4 through an IP extension network 5. A voice mail apparatus 6 for the IP telephone terminals 2 to 2i is connected to the IP extension network 5.

The non-IP telephone terminals 3 to 3i are connected to the IP telephone exchange 4 through a non-IP extension network 7. A voice mail apparatus 8 for the non-IP telephone terminals 3 to 3i is connected to the non-IP extension network 7. The IP telephone exchange 4 is connected to the IP extension network 5, the non-IP extension network 7, and a public switched telephone network (PSTN/ISDN) 9 and establishes communications among the IP telephone terminals 2, the non-IP telephone terminals 3, and the public switched telephone network 9 through the networks for allowing conversations. The IP telephone exchange 4 includes a plurality of voice channels (DSPs) 10 and a control channel 11. The voice channels (DSPs) 10 interconverts between voice data and voice data, which are transferred between the IP telephone terminal 2 and the non-IP telephone terminal 3, namely, interconverts between IP voice data (UDP packet) and non-IP voice data (PCM data). The control channel 11 communicates a call request signal, a hold command signal, a transfer command signal, etc., from the IP telephone terminal 2 and/or the non-IP telephone terminal 3. It is assumed that the number of the voice channels 10 is less than the total number of the IP telephone terminals 2 connected to the IP telephone exchange 4.

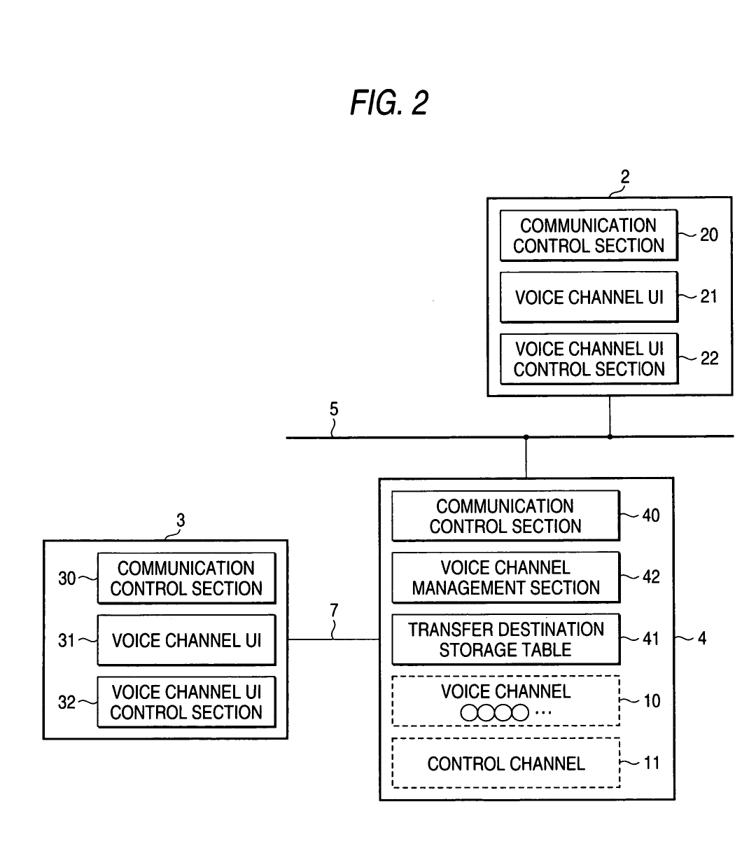

FIG. 2 is a block diagram of the IP telephone exchange system 1 to show functional blocks of the IP telephone terminal 2, the non-IP telephone terminal 3, and the IP telephone exchange 4.

In FIG. 2, the IP telephone terminal 2 includes a communication control section 20, a voice channel UI (User Interface) 21 and a voice channel UI control section 22. The communication control section 20 conducts communications of a call control signal and data with the IP telephone exchange 4. The voice channel UI (User Interface) 21 includes an LCD (Liquid Crystal Display), an LED (Light Emitting Diode), a hold button, a transfer button, etc., described later. The voice channel UI control section 22 processes the operation signals of the voice channel UI 21. Likewise, the non-IP telephone terminal 3 includes a communication control section 30, a voice channel UI (User Interface) 31 and a voice channel UI control section 32. The communication control section 30 conducts communications of a call control signal and data with the IP telephone exchange 4. The voice channel UI (User Interface) 31 includes an LCD (Liquid Crystal Display), an LED (Light Emitting Diode), a hold button, a transfer button, etc., described later. The voice channel UI control section 32 processes the operation signals of the voice channel UI 31. The IP telephone exchange 4 includes a communication control section 40, a voice channel management section 42, a transfer destination storage section 41, the voice channels 10 and the control channel 11. The communication control section 40 conducts communications of a call control signal and data with the IP telephone terminal 2 and the non-IP telephone terminal 3. The voice channels (DSPs) 10 interconverts between IP voice data and non-IP voice data. The control channel 11 communicates a call request signal, a hold command signal, a transfer command signal, etc., from the IP telephone terminal 2 and/or the non-IP telephone terminal 3. The transfer destination storage table 41 stores a transfer destination of an incoming call, which is set for each of the IP telephone terminals 2 and the non-IP telephone terminals 3. The voice channel management section 42 detects the presence or absence of an available voice channel 10 and performs predetermined control in response to the presence or absence when communication connection is established between the IP telephone terminal 2 and the non-IP telephone terminal 3 in response to a call request from one telephone terminal.

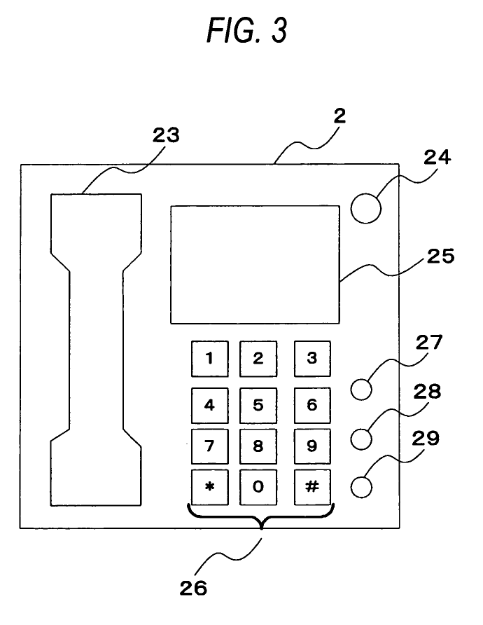

FIG. 3 is a plan view to show the appearance of the IP telephone terminal 2. As shown in FIG. 3, the IP telephone terminal 2 includes a handset 23, an LED 24, an LCD 25, dial keys 26, a hold button 27 for entering a hold command, a transfer button 28 for entering a transfer command of transferring an incoming call to a previously registered transfer destination, and a play button 29 for playing back a message recorded in the voice mail apparatus. Although FIG. 3 shows the configuration of the IP telephone terminal 2 is described, the non-IP telephone terminal 3 also has the similar configuration.

Next, the basic operation of the described IP telephone exchange 4 will be described. First, when a call request signal is received from the non-IP telephone terminal 3 through the control channel 11, the destination is determined using a table (not shown) or the like and the call request signal is transmitted to the IP telephone terminal 2, which is the destination of the call request, for example, through the control channel 11. Upon receiving the call request signal, the IP telephone terminal 2 produces a ringing tone. When the user lifts the handset 23 of the IP telephone terminal 2 (offhook), communication connection is established between the calling non-IP telephone terminal 3 and the called IP telephone terminal 2. When the communication connection is established therebetween, the voice channel management section 42 detects whether or not one available voice channel 10 exists. If an available voice channel 10 exists, the voice channel control section 42 captures the available voice channel 10 and causes it to interconvert between IP voice data and non-IP voice data, which is exchanged between the calling non-IP telephone terminal 3 and the called IP telephone terminal 2, for allowing voice data to be exchanged therebetween, that is, conversation therebetween.

The basic operation of the IP telephone terminal 2 will be described. First, when the user lifts the handset 23 and operates the dial keys 26 to enter the telephone number of the destination, the destination telephone number is transmitted to the IP telephone exchange 4 and further a call request signal is transmitted to the telephone terminal of the destination, thereby to cause the called telephone terminal to ring. When the user lifts the handset of the called telephone terminal (offhook), communication connection with the called party is established for allowing the users to have a conversation by exchanging voice data between the telephone terminals. If the user presses the hold button 27 during the conversation, a hold command signal is transmitted to the control channel 11 and the IP telephone exchange 4 holds the communications and transmits a hold signal to both the terminals during the conversation. If the user again presses the hold button 27, a hold release signal is transmitted to the control channel 11 and the IP telephone exchange 4 releases the hold state and again establishes the communications. When the communication connection is established, if a voice channel 10 cannot be captured in the IP telephone exchange 4 and a notification signal indicating that a voice channel 10 cannot be captured is received through the control channel 11 from the voice channel management section 42 of the IP telephone exchange 4, the LED 24 turns on. The LCD 25 displays various operation guidance messages, etc. Upon receiving the notification signal, the LDC 25 displays a message that a voice channel 10 cannot be captured, such as a message of “conversations concentrate and voice channel cannot be used.” If the user operates the transfer button 28 while the LED 24 is on or the message “conversations concentrate and voice channel cannot be used” is displayed on the LDC 25, a command signal for transferring the call to the transfer destination previously registered in the transfer destination storage table 41 is transmitted to the IP telephone exchange 4. Upon receiving the transfer command, the IP telephone exchange 4 transfers the call to the transfer destination previously registered in the transfer destination storage table 41. At this time, preferably the previously registered transfer destination is a non-IP telephone. That is, it is preferable that a terminal not requiring any voice channel 10 in transferring voice data is previously registered. If the IP telephone terminals communicate with each other or the non-IP telephone terminals communicate with each other, voice data conversion need not be executed. Therefore, voice data can be transferred without the intervention of the voice channel 10.

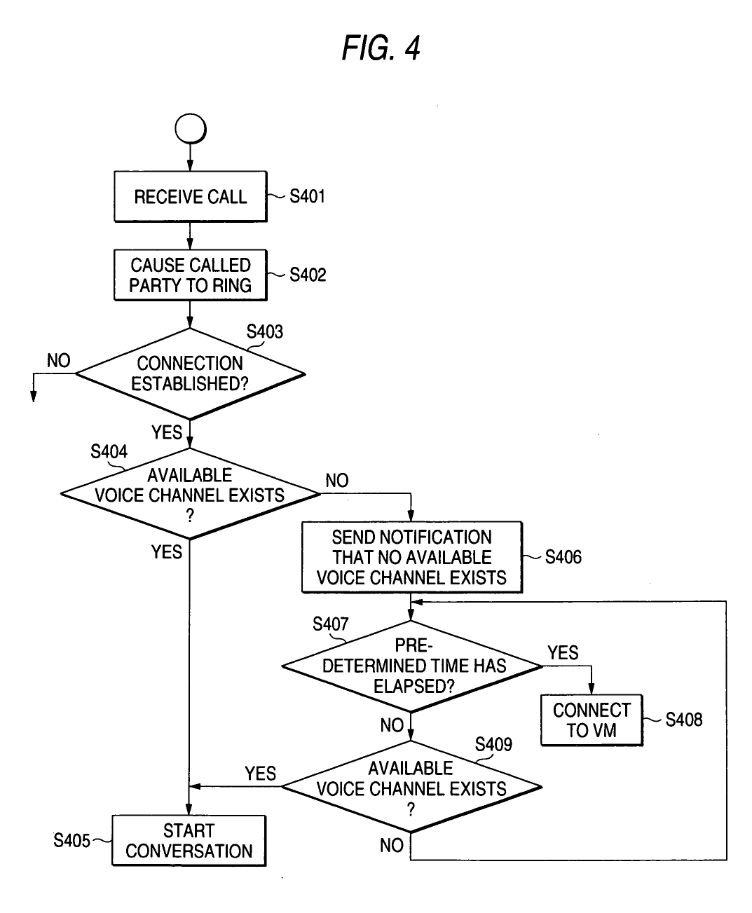

Next, the operation of the IP telephone exchange 4 when the users of the non-IP telephone terminal 3 and the IP telephone terminal 2 have a telephone conversation and a voice channel 10 cannot be captured will be described with a flowchart of FIG. 4.

To begin with, a call request signal is received from the non-IP telephone terminal 3 (S401). When the call request signal is received, the destination is determined based on the destination telephone number and the call request signal is transmitted to the IP telephone terminal 2 of the destination (S402). It is detected whether or not the user of the called IP telephone terminal 2 lifts the handset to off the hook and connection is established (S403). If communication connection is established, it is detected whether or not an available voice channel 10 exists (S404). If an available voice channel 10 is detected, the available voice channel 10 is captured and voice data is transferred between the calling non-IP telephone terminal 3 and the called IP telephone terminal 2 (S405). If an available voice channel 10 cannot be captured at step 404, a notification signal indicating that an available voice channel 10 cannot be captured is transmitted to the calling non-IP telephone terminal 3 and the called IP telephone terminal 2 (S406). After the notification signal is transmitted, it is checked whether or not a predetermined time, for example, 15 seconds has elapsed (S407). When 15 seconds has elapsed, the calling non-IP telephone terminal 3 is connected to the voice mail apparatus 8 and the user of the non-IP telephone terminal 3 is prompted to record a message (S408). Detection of an available voice channel 10 is continued for 15 seconds (S409), and if an available voice channel 10 is detected and is captured, the IP telephone exchange 4 goes to step 405 for establishing telephone conversation as described above.

If a notification signal indicating that an available voice channel 10 cannot be captured is transmitted to the calling non-IP telephone terminal 3 and the called IP telephone terminal 2 at step 406, the LEDs 24 of the telephone terminals 2 and 3 turn on and a message of “conversations concentrate and voice channel cannot be used” is displayed on each LDC 25.

Thus, in the case where the voice data cannot be exchanged due to short of the voice channel although communications are established between the non-IP telephone terminal 3 and the IP telephone terminal 2 by ringing of the call request, the calling party and the called party are notified accordingly. Therefore, it is made possible to make the calling party and called party understand the unnatural state and prompt to make a call request again after a predetermined time. If an available voice channel 10 cannot be captured although predetermined time has elapsed, the user is prompted to record a message in the voice mail apparatus 8. Therefore, it is made possible for the user of the called party who could not have a conversation to listen to the message in a predetermined time, and the calling party need not again make a call request.

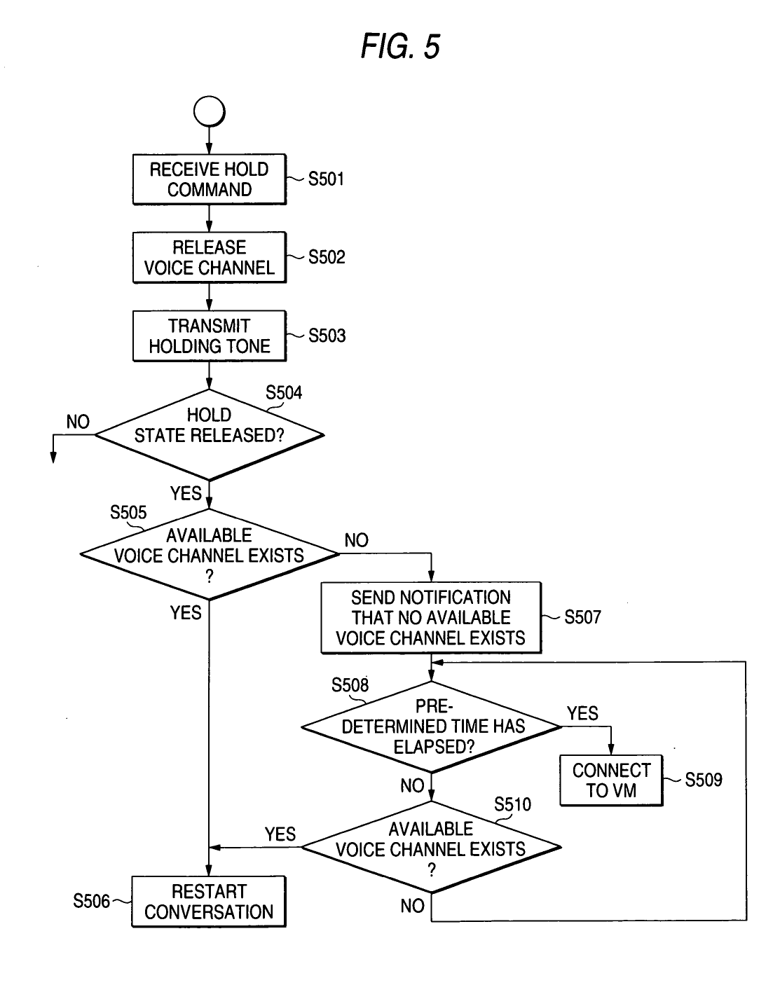

FIG. 5 is a flowchart to describe the operation of the IP telephone exchange 4 when the hold button 27 of either the non-IP telephone terminal 3 or the IP telephone terminal 2 is operated while the non-IP telephone terminal 3 and the IP telephone terminal 2 are having a conversation.

If the hold button 27 is operated during the telephone conversation between the non-IP telephone terminal 3 and the IP telephone terminal 2 (S501), the voice channel 10 occupied by the telephone conversation is released (S502) and a holding tone is transmitted to the calling non-IP telephone terminal 3 and the called IP telephone terminal 2 (S503). If the hold button 27 is again operated during the hold state and a hold release signal is received (S504), it is detected whether or not an available voice channel 10 exists (S505). If an available voice channel 10 is detected, the available voice channel 10 is captured and voice data is exchanged between the calling non-IP telephone terminal 3 and the called IP telephone terminal 2 (S506). If an available voice channel 10 cannot be captured at step 505, a notification signal indicating that an available voice channel 10 cannot be captured is transmitted to the calling non-IP telephone terminal 3 and the called IP telephone terminal 2 (S507). After the notification signal is transmitted, it is checked whether or not a predetermined time, for example, 15 seconds has elapsed is checked (S508). When 15 seconds has elapsed, the calling non-IP telephone terminal 3 is connected to the voice mail apparatus 8 and the user of the non-IP telephone terminal 3 is prompted to record a message (S509). Detection of an available voice channel 10 is continued for 15 seconds (S510) and if an available voice channel 10 is detected and is captured, the IP telephone exchange 4 goes to step 506 for again establishing telephone conversation.

Thus, if the hold button 27 is operated during the telephone conversation between the non-IP telephone terminal 3 and the IP telephone terminal 2, the voice channel 10 is released, whereby the occasions of using the limited voice channels unnecessarily can be decreased and the effective use of the voice channels can be made. When the hold state is released, if an available voice channel 10 does not exist, the calling and called parties is notified that no available voice channel exists. Therefore, it is made possible to make the calling and called parties understand the unnatural state and prompt to make a call request again after a predetermined time.

### Second Embodiment

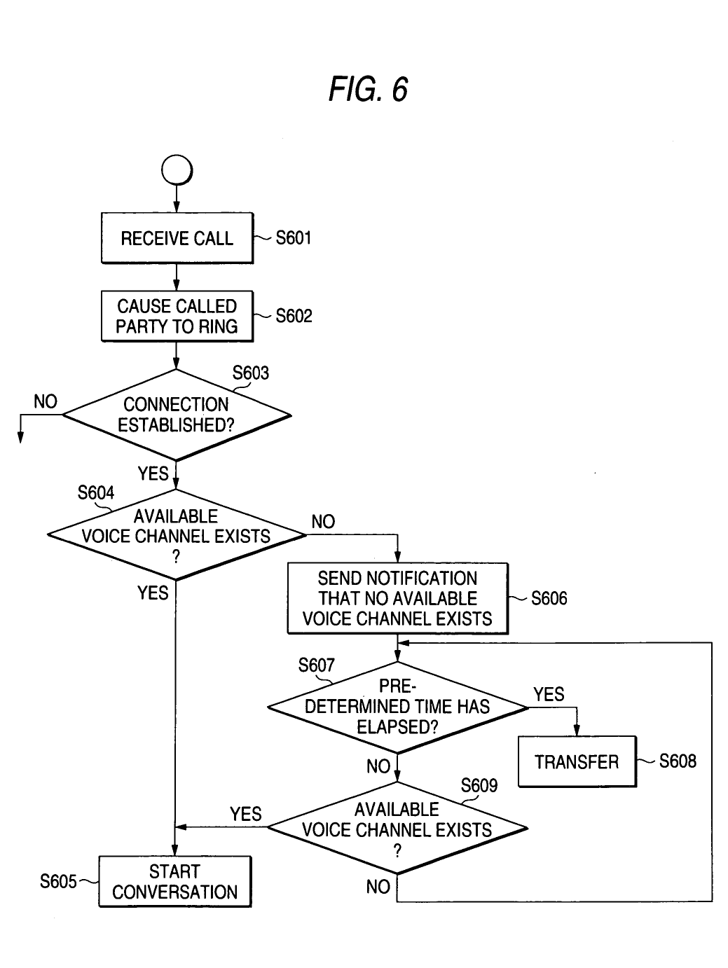

Next, a second embodiment of the invention will be described with a flowchart of FIG. 6. FIG. 6 is a flowchart to show the operation of an IP telephone exchange 4 when a non-IP telephone terminal 3 and an IP telephone terminal 2 attempt to establish connection therebetween but a voice channel 10 cannot be captured.

To begin with, a call request signal is received from the non-IP telephone terminal 3 (S601). When the call request signal is received, the destination is determined based on the destination telephone number and the call request signal is transmitted to the IP telephone terminal 2 of the destination (S602). It is detected whether or not the user of the called IP telephone terminal 2 lifts the handset to off the hook and connection is established (S603). If communication connection is established, it is detected whether or not an available voice channel 10 exists (S604). If an available voice channel 10 is detected, the voice channel 10 is captured and voice data is transferred between the calling non-IP telephone terminal 3 and the called IP telephone terminal 2 (S605). If an available voice channel 10 cannot be captured at step 604, a notification signal indicating that an available voice channel 10 cannot be captured is transmitted to the calling non-IP telephone terminal 3 and the called IP telephone terminal 2 (S606). After the notification signal is transmitted, it is checked whether or not a predetermined time, for example, 15 seconds has elapsed is checked (S607). When 15 seconds has elapsed, the incoming call from the calling non-IP telephone terminal 3 is transferred to the transfer destination telephone terminal previously registered in a transfer destination storage table 41 (608). Detection of an available voice channel 10 is continued for 15 seconds (S609). If an available voice channel 10 is detected and is captured, the IP telephone exchange 4 goes to step 605 for establishing telephone conversation.

Thus, in the case where the voice data cannot be exchanged due to short of the voice channel although communications are established between the non-IP telephone terminal 3 and the IP telephone terminal 2 by ringing of the call request, the calling party and the called party are notified accordingly. Therefore, it is made possible to make the calling party and called party understand the unnatural state and prompt to make a call request again after a predetermined time. If a voice channel 10 cannot be captured although predetermined time has elapsed, the call can be transferred to the telephone terminal of the transfer destination previously registered. Thus, if another non-IP telephone terminal is previously registered as the transfer destination, conversation not requiring any voice channel 10 is made possible, and the calling party needs not again make a call.

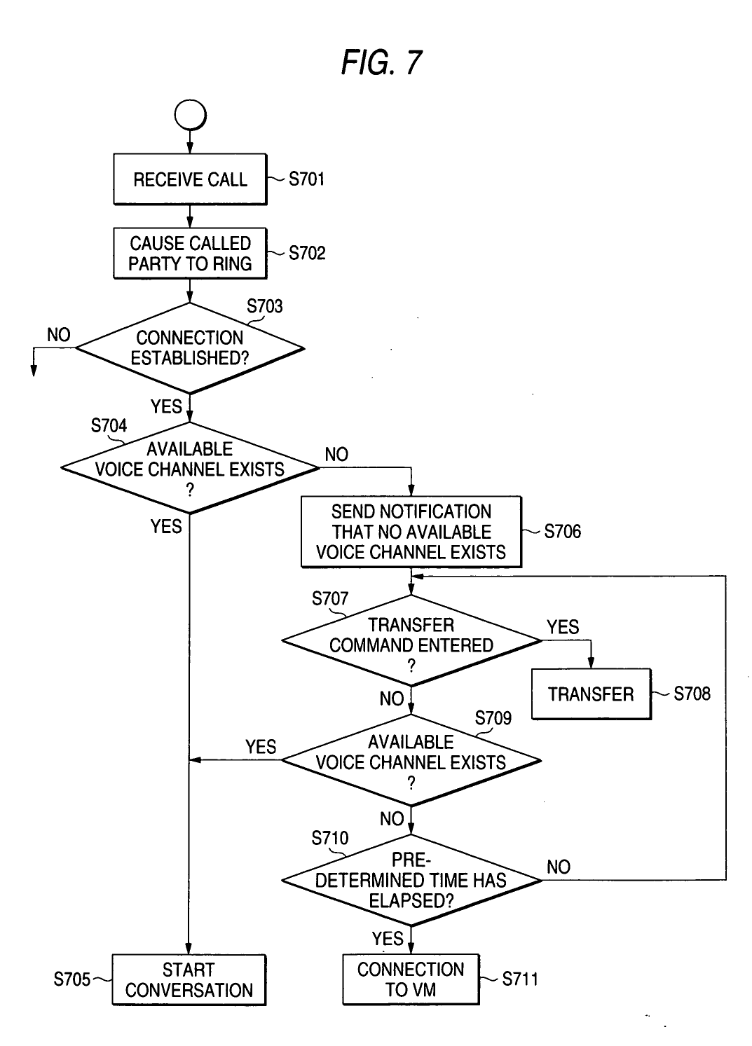

FIG. 7 is a flowchart to show the operation of the IP telephone exchange 4 for sending a notification and enabling the user of the called telephone terminal to enter a transfer command when the non-IP telephone terminal 3 and the IP telephone terminal 2 attempt to establish connection therebetween and a voice channel 10 cannot be captured.

To begin with, a call request signal is received from the non-IP telephone terminal 3 (S701). When the call request signal is received, the destination is determined based on the destination telephone number and the call request signal is transmitted to the IP telephone terminal 2 of the destination (S702). It is detected whether or not the user of the called IP telephone terminal 2 lifts the handset to off the hook and connection is established (S703). If communication connection is established, it is detected whether or not an available voice channel 10 exists (S704). If an available voice channel 10 is detected, the available voice channel 10 is captured and voice data is transferred between the calling non-IP telephone terminal 3 and the called IP telephone terminal 2 (S705). If an available voice channel 10 cannot be captured at step 704, a notification signal indicating that an available voice channel 10 cannot be captured is transmitted to the calling non-IP telephone terminal 3 and the called IP telephone terminal 2 (S706). After the notification signal is transmitted, it is checked whether or not the user operates a transfer button 28 to enter a transfer command (S707). If the transfer command is entered, the incoming call from the calling non-IP telephone terminal 3 is transferred to the transfer destination telephone terminal previously registered in the transfer destination storage table 41 (S708). If the transfer command is not entered, it is checked whether or not an available voice channel 10 exists (S709). If an available voice channel 10 can be captured, the IP telephone exchange 4 goes to step 705 for starting telephone conversation. If an available voice channel 10 cannot be captured, it is checked whether or not a predetermined time has elapsed (S710). When the predetermined time has elapsed, the calling non-IP telephone terminal 3 is connected to a voice mail apparatus 8 and the user of the non-IP telephone terminal 3 is prompted to record a message (S711).

Thus, when the users of the non-IP telephone terminal 3 and the IP telephone terminal 2 have a conversation, if a voice channel 10 cannot be captured, the users are notified that an available voice channel 10 cannot be captured, and the user of the called telephone terminal is enabled to enter a transfer command. Therefore, transfer or connection to the voice mail apparatus 8 can be selected in response to the intention of the user of the called IP telephone terminal 2 and the operability is furthermore improved.

In the description of the embodiments, a call is originated from the non-IP telephone terminal 3 to the IP telephone terminal 2 by way of example. However, similar operation is also made if a call is originated from the IP telephone terminal 2 to the non-IP telephone terminal 3.

What is claimed is:

1. An IP telephone exchange for connecting at least one IP telephone terminal connected to an IP network and at least one non-IP telephone terminal connected to a non-IP network to enable conversation between the IP telephone terminal and the non-IP telephone terminal, the IP telephone exchange comprising:
a communication control section that conducts data communications with the IP telephone terminal and the non-IP telephone terminal;
a voice channel that interconverts between non-IP voice data and IP voice data;
a control channel that communicates a call control signal with the IP telephone terminal and the non-IP telephone terminal; and
a voice channel management section that detects presence or absence of an available voice channel when communication connection is established between the IP telephone terminal and the non-IP telephone terminal on a basis of the call control signal, the voice channel management section that notifies a calling telephone terminal and a called telephone terminal that no available voice channel exists, if the voice channel management section detects no available voice channel.

2. The IP telephone exchange according to claim 1, wherein:
upon receiving a conversation hold command signal, the voice channel management section releases an occupied voice channel, and
when a hold state is released, the voice channel management section detects presence or absence of an available voice channel and if the voice channel management section detects no available voice channel, the voice channel management section notifies the calling and called telephone terminals that no available voice channel exists.

3. The IP telephone exchange according to claim 1 wherein:
if the voice channel management section detects no available voice channel, the voice channel management section monitors presence or absence of an available voice channel for a predetermined time, and
if the voice channel management section captures an available voice channel within the predetermined time, the voice channel management section causes the captured voice channel to interconvert between non-IP voice data and IP voice data communicated between the IP telephone terminal and the non-IP telephone terminal.

4. The IP telephone exchange according to claim 3, further comprising:
a control unit that connects the calling telephone terminal to a voice mail apparatus, wherein:
if the voice channel management section captures no available voice channel within the predetermined time, the control unit connects the calling telephone terminal to the voice mail apparatus.

5. An IP telephone exchange for connecting at least one IP telephone terminal connected to an IP network and at least one non-IP telephone terminal connected to a non-IP network to enable conversation between the IP telephone terminal and the non-IP telephone terminal, the IP telephone exchange comprising:
a communication control section that conducts data communications with the IP telephone terminal and the non-IP telephone terminal;
a voice channel that interconverts between non-IP voice data and IP voice data;
a control channel that communicates a call control signal with the IP telephone terminal and the non-IP telephone terminal; and
a transfer destination storage unit that stores a transfer destination for each of the IP telephone terminal and the non-IP telephone terminal; and
a voice channel management section that detects presence or absence of an available voice channel when communication connection is established between the IP telephone terminal and the non-IP telephone terminal as the call control signal is communicated by the control channel, and transfers the incoming call to the predetermined transfer destination stored in the transfer destination storage means if no available voice channel is detected.

6. The IP telephone exchange according to claim 5, wherein:
if the voice channel management section detects no available voice channel, the voice channel management section monitors presence or absence of an available voice channel for a predetermined time, and
if the voice channel management section captures an available voice channel within the predetermined time, the voice channel management section causes the captured voice channel to interconvert between non-IP voice data and IP voice data communicated between the IP telephone terminal and the non-IP telephone terminal.

7. An IP telephone terminal connected to an IP network, the IP telephone terminal for communicating with at least one non-IP telephone terminal connected to a non-IP network through an IP telephone exchange, the IP telephone terminal comprising:
a communication control section that conducts data communications with the IP telephone exchange; and
a notification unit that sends a notification that an available voice channel for interconverting between non-IP voice data and IP voice data does not exist.

8. The IP telephone terminal according to claim 7 further comprising:
a transfer button that enters a transfer command for transferring a call from a calling party to a previously registered telephone terminal after the notification unit sends the notification that the available voice channel does not exist.
